(19) United States
(12) Patent Application Publication
(10) Pub. No.: US 2009/0245989 A1
(43) Pub. Date: Oct. 1, 2009

(54) SYSTEM AND METHOD FOR CONSTRUCTION WASTE REMOVAL

(76) Inventor: Sheldon Mickelson, Wellington, FL (US)

Correspondence Address: CAREY, RODRIGUEZ, GREENBERG & PAUL LLP;ATTN: STEVEN M. GREENBERG, ESQ., 950 PENINSULA CORPORATE CIRCLE, SUITE 3020, BOCA RATON, FL, 33487, US

(21) Appl. No.: 12/058,426

(22) Filed: Mar. 28, 2008

(51) Int. Cl. B65F 3/02; B65F 3/14; B65H 31/32; B65G 65/04; B65G 65/34

(52) U.S. Cl. 414/487; 414/509; 414/790.5; 414/807; 414/810

(57) ABSTRACT

Embodiments of the present invention address deficiencies of the art in respect to construction waste removal and provide a method, system and apparatus for construction waste removal. In one embodiment of the invention, a construction waste removal system can be provided. The system can include an assembled waste chute, the assembled waste chute comprising a set of waste chute sections that are joined together in an end-to-end matter and a collapsible waste container configured to receive waste from a downstream end of the assembled waste chute. The system further can include a waste transport vehicle including a main frame disposed along the longitudinal axis of the waste transport vehicle, a grasping mechanism configurable for removing waste from the collapsible waste container and disposed adjacent to an operator cab, and a waste-receiving vehicle bed coupled to the main frame. The system yet further can include a pair of extension flaps rotatably connected to a pair of sidewalls and configured to retain the construction waste in the waste-receiving vehicle bed while the construction waste is being compacted.

### BACKGROUND OF THE INVENTION

1. Field of the Invention

The present invention relates to the field of waste removal and more particularly to waste removal from construction sites, commercial sites, industrial waste sites, town houses, multi-family homes and condominiums.

2. Description of the Related Art

At construction sites for new construction, remodeling, building refurbishment or modernization, and at industrial waste sites, one of the problems faced by the builder, construction company or business is the removal of substantial amounts of waste, debris and garbage. Conventional ways for waste, debris and garbage removal at construction and industrial sites are accomplished by locating multiple containers or bins at various waste collection locations at the construction or industrial site. Typical containers or bins are approximately twenty feet long, six to eight feet wide and three to eight feet deep. These containers are typically referred to as “roll-off” containers and may have wheels to make the stationary roll-off containers into mobile roll-off containers. Such roll-off containers usually have three standard sizes: one size is twenty cubic yards, a second size is thirty cubic yards and the other size is about forty cubic yards.

Since all roll-off containers have different trash weight and capacity, which is dependent upon the ability of an associated “roll-off truck” to pick up the loaded containers and upon state and/or local restrictions, the size of roll-off container selected depends upon the weight of trash or other materials to be dumped therein. For example, the twenty yard roll-off containers are typically most efficiently used on construction sites for heavy waste materials, such as broken masonry, concrete and asphalt; earth; bricks and tile. The thirty and forty yard roll-off containers are typically constrained to receiving lighter-weight materials, such as scrap lumber, plasterboard, broken shingles, tree branches and trimmings, business and household garbage and typical packaging waste such as corrugated cardboard, cardboard and packing materials. Regardless of which roll-off container is selected, these roll-off containers are too heavy for trucks having front or rear end loaders to lift and empty the construction waste materials. Instead, an associated “roll-off truck” will pick up the roll-off container.

Such associated roll-off trucks typically have a power-tiltable flat bed with a power winch at the front (cab) end thereof. When a roll-off container is to be on-loaded onto the roll-off truck, for example, so that, when empty, the container can be delivered to an intended use site or so that, when filled, it can be hauled to a dumping site, the roll-off truck backs up to the forward end of the container. The front end of the truck bed is then tilted upwardly until the rear end of the bed is near the ground or pavement. A cable from the power winch is attached to the forward end of the roll-off container to on-load onto the truck and the container is winched up onto the roll-off frame of the truck bed, the container rolling on its wheels. When the container is winched all the way onto the roll-off frame of the truck bed, the container is locked in place and the truck bed is tilted back to its normal, horizontal position. Empty roll-off containers are off-loaded from the roll-off truck at a storage facility or at an intended use site by reversing the above-described on-loading procedure.

The above technique using a roll-off truck is inefficient and time consuming. As the roll-off truck processes a single roll-off container at a time, then for each roll-off container at the construction site, a separate trip to the waste handling facility is necessary, even for those roll-off containers that may contain a less than full load. Another problem with the above technique is that conventional roll-off containers are made as single integrated units, constructed of heavy materials such as metal and cannot be disassembled. As such, each roll-off container has a fixed footprint that requires a set amount of space at the construction site regardless of whether that roll-off container is in use or is waiting to be used. Many construction sites have limited space available to place waste containers, much less store empty roll-off containers.

Another problem concerns emptying the roll-off containers. It is common for the central repository to have special large dumping equipment designed to lift the bins and invert them to empty the waste contents. This dumping equipment is expensive and often requires skilled personnel to operate it. Moreover, there is no way to compact the waste in the roll-off containers in order to place more waste in that sized roll-off container, e.g., a thirty, forty, sixty, seventy-five or one hundred cubic yard container, to properly fill that sized roll-off container to capacity. Accordingly, regardless of the amount of actual waste in the roll-off container, which will typically be significantly less than the container capacity, the central waste repository will charge the full price associated with that sized container instead of a lesser amount based on the actual amount of construction waste in the container.

### BRIEF SUMMARY OF THE INVENTION

Embodiments of the present invention address deficiencies of the art in respect to construction waste removal and provide a novel and non-obvious method, system and apparatus for waste removal at construction and industrial sites. In one embodiment of the invention, a system for construction waste removal can be provided. The system can include an assembled waste chute, the assembled waste chute comprising a set of waste chute sections that are joined together in an end-to-end manner and a collapsible waste container configured to receive waste from a downstream end of the assembled waste chute. The system further can include a waste transport vehicle including a main frame disposed along the longitudinal axis of the waste transport vehicle, a grasping mechanism disposed adjacent to an operator cab that is configurable for removing waste from the collapsible waste container, and a waste-receiving vehicle bed coupled to the main frame. The system yet further can include a pair of extension flaps rotatably connected to a pair of sidewalls and configured to extend the sidewalls of the waste-receiving vehicle bed to assist in retaining the construction waste in the waste-receiving vehicle bed while the construction waste is being compressed, e.g., using the grasping mechanism.

In another embodiment of the invention, a method for construction waste removal can be provided. The method can include transporting a set of waste chute sections to a construction site, assembling a waste chute by joining the set of waste chute sections together in an end-to-end matter and installing the waste chute into a multi-story building. In one aspect of the embodiment, the method further can include transporting one or more collapsible waste containers to a construction site, assembling the collapsible waste container by connecting the various side members to the base member and to the corresponding adjacent side member, positioning the one or more collapsible waste containers to receive waste from a downstream end of the installed waste chute and receiving waste from a downstream end of the installed waste chute. In another aspect of the embodiment, the method yet further can include providing a waste transport vehicle, removing the received waste from the collapsible waste container and placing it in a waste-receiving bed of the waste transport vehicle. The received waste from the collapsible waste container can be packed or compressed into the waste-receiving bed of the waste transport vehicle by use of a grasping mechanism.

In yet another embodiment of the invention, a method for removing waste from waste containers can be provided. The method can include transporting a waste collection vehicle to a plurality of waste containers, positioning the waste collection vehicle adjacent one of the plurality of waste containers and deploying a pair of extension flaps rotatably connected to a pair of sidewalls coupled to a waste-receiving bed of the waste collection vehicle. The method can further include activating a grasping mechanism located at a distal end of a boom of the waste collection vehicle, removing waste from the one of the plurality of waste containers using the grasping mechanism, placing the removed waste in the waste-receiving bed of the waste collection vehicle and using the grasping mechanism to compress the removed waste placed in the waste-receiving bed of the waste collection vehicle.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram of a waste disposal chute and waste container of a waste delivery system constructed in accordance with the principles of the present invention;

FIG. 2 is a perspective view of a waste grappler truck of a waste delivery system constructed in accordance with the principles of the present invention;

FIG. 3 is a perspective view of a single section of the waste disposal chute shown in FIG. 1 and constructed in accordance with the principles of the present invention;

FIG. 4 is a perspective view of a side angle hopper of the waste disposal chute section shown in FIG. 3, and constructed in accordance with the principles of the present invention; and,

FIG. 5 is a perspective view of a grasping mechanism of the waste grappler truck shown in FIG. 2, and constructed in accordance with the principles of the present invention.

### DETAILED DESCRIPTION OF THE INVENTION

Embodiments of the present invention provide a method, system and apparatus for removing construction waste from a construction site. In accordance with an embodiment of the present invention, at a construction site, multiple chute sections can be joined together in an end-to-end manner to construct a waste disposal chute of a waste removal system. The constructed or assembled waste disposal chute can be installed on a multi-story building. A collapsible construction waste container in a disassembled state can be transported to the construction site. The collapsible waste container can be assembled and then positioned so that it can receive waste from a downstream end of the waste disposal chute. A waste transport vehicle having a grasping mechanism, e.g., a grappler, that is configured to remove construction waste collected in the collapsible waste container, to load the waste into a waste-receiving bed of the waste transport vehicle and to transport the collected waste to a central waste repository can be provided to the construction waste removal system.

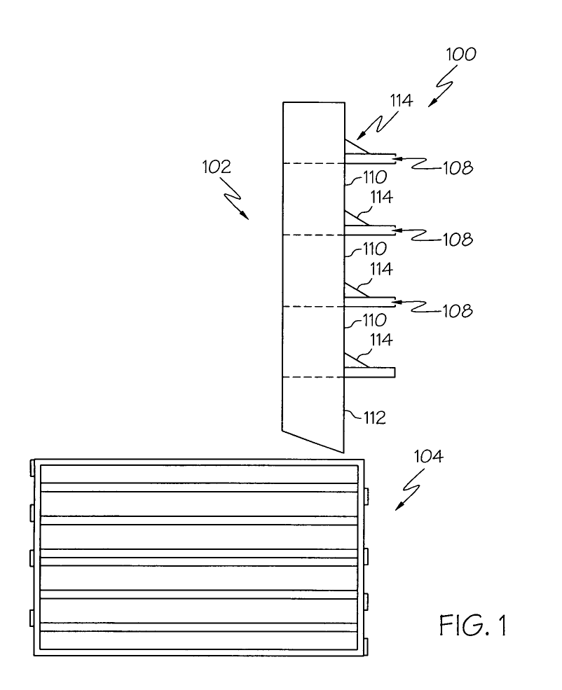

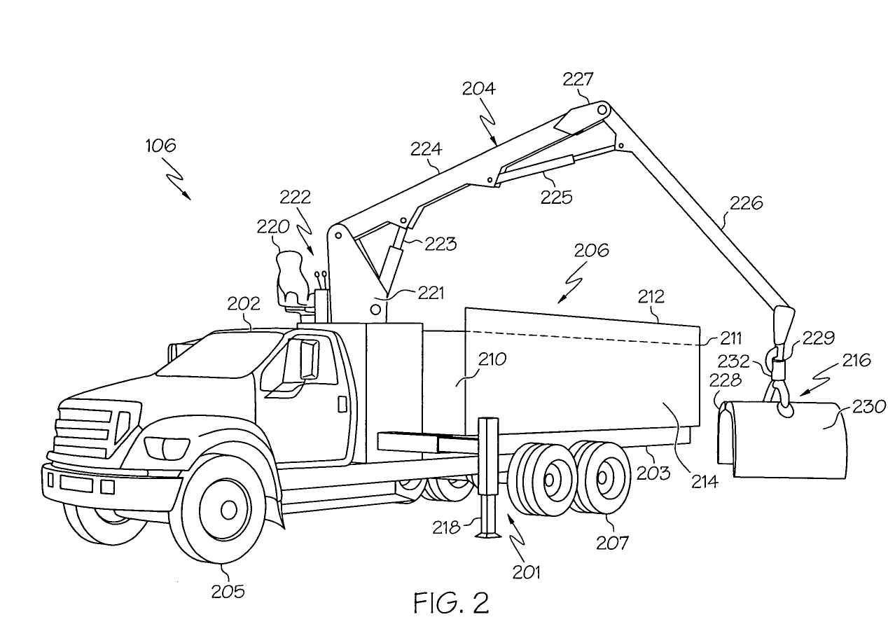

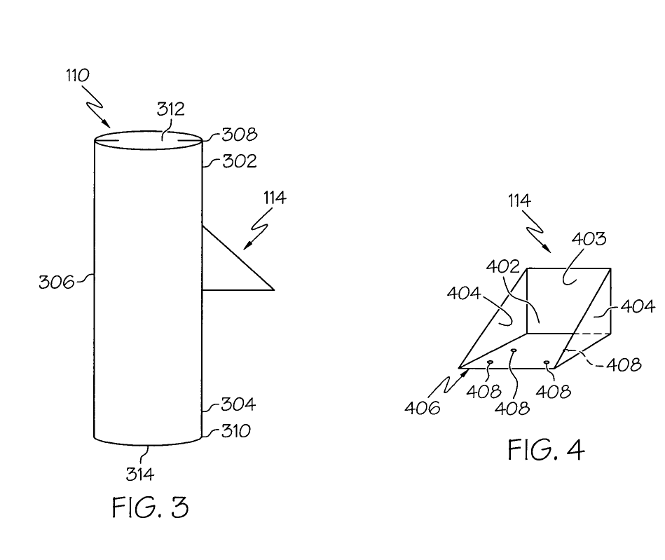

In further illustration, FIG. 1 is a diagram of a waste disposal chute and waste container of a waste delivery system constructed in accordance with the principles of the present invention. As shown in FIG. 1, a waste delivery system 100 can include a waste disposal chute 102, a waste container 104 and a waste transport vehicle 106 (FIG. 2) having a grasping device 204, e.g., a grappler arm. The waste disposal chute 102 can include multiple chute sections 110 and a terminating chute section 112. Each of the chute sections 110 can include an opening, which is located in close proximity to a side angle hopper 114. The base of the side angle hopper 114 can attach to a building floor 108 of the multi-story building. The height between the floors of a building will usually vary from about ten feet six inches to about fifteen feet six inches. A more detailed description of chute section 110 is provided below with reference to FIG. 3.

The waste container 104 is a collapsible waste container that can be can be assembled and then positioned so that it can receive waste from a downstream end, e.g., chute section 112, of the waste disposal chute 102. For example, as shown in FIG. 1, the collapsible waste container 104 is positioned under the output end of chute section 112. Collapsible waste container 104 can include a plurality of walls, e.g., a pair of detachable side walls, a detachable front wall, a detachable back wall, and a detachable bottom than interlocks with the plurality of walls. For further details of a structure of the collapsible waste container 104, reference may be had to the commonly assigned patent application Ser. No. ______, entitled, “Construction Waste Removal Container”, which is being filed concurrently with this application and the entirety of which is incorporated by reference herein.

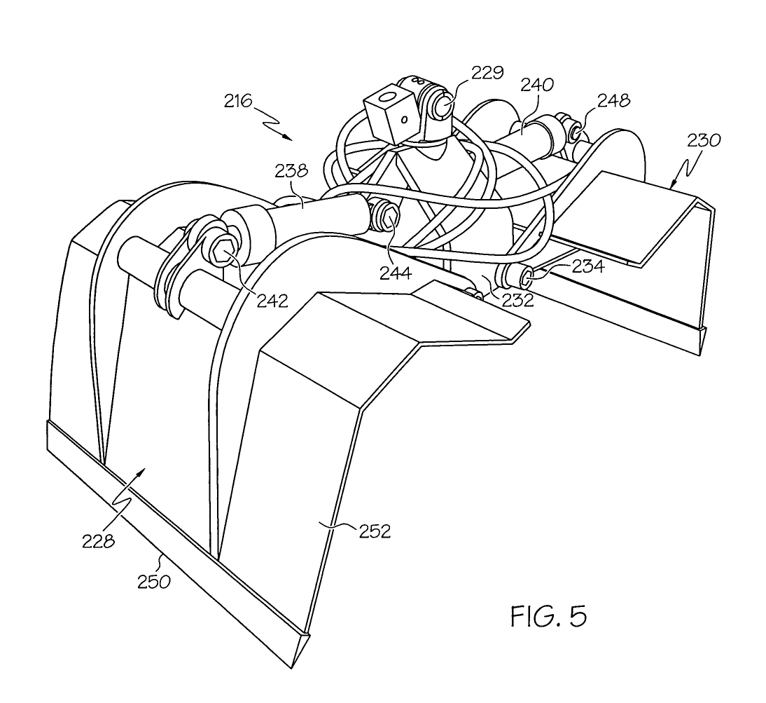

In yet further illustration, FIG. 2 is a perspective view of a waste grappler truck of a waste delivery system constructed in accordance with the principles of the present invention. As illustrated in FIG. 2, waste grappler truck 106 of waste delivery system 100 can include a chassis 201 that can include a main frame 203 disposed along the longitudinal axis of the truck 106 and supported by front and rear wheels 205 and 207, respectively. The main frame 203 can further include an operator cab 202, a boom 204 and a waste-receiving truck bed 206. The operator cab 202 can be mounted on the chassis 201 at the front of the truck 106. The chassis 201 can further mount adjacent the operator cab 202, the boom 204, which in turned mounts a material grasping mechanism 216 in the form of a grappler. As illustrated in FIG. 5, in embodiments, the grasping mechanism 216, e.g., a grappler, can have a base 232 and a first jaw 228 and a second jaw 230 pivotally connected to the base 232 by pivot pins 234 and 236, respectively. Base 232 in turn can be coupled to the boom 204 by a pivot pin 229. The opening and closing of the first and second jaws 228 and 230 can be activated by another pair of hydraulic members 238, 240 and controlled from an operator control console 222 at an operator station 220. The boom 204 can include relatively pivotal and extendable members 224 and 226 interconnected by a pivot 227 and a selectively operable hydraulic cylinder 225 to power relative movement between the boom members 224 and 226. Another hydraulic cylinder 223 can be interposed between a brace 221 and the boom element 224 such that the attitude of the boom element 224 can be varied. In this manner, the grappler device 216 can be moved from a storage position to a working position, such as when the grappler is placed into the receiving area of a collapsible waste container 104.

Upon customization of the grasping mechanism 216, the jaws 228, 230 can have a cutting edge 250 of approximately 48 inches in length, which can be made of hardened steel. In embodiments, the width of the grasping mechanism 216 can be increased by welding one-half inch thick formed steel plate extensions to the grasping mechanism 216. Notably, the increased width of the grasping mechanism provides for a greater waste-engaging surface area 252 on the outer side of jaws 228 and 230, which can improve the crushing and compressing ability of the grasping mechanism 216 when the grappler 216 is crushing, compacting and/or compressing waste, debris and garbage loaded into the waste-receiving truck bed 206. Consequently, the speed in which the waste-receiving truck bed 206 can be loaded and compressed is significantly enhanced by increasing the working surface area 252 of the jaws 228 and 230. When fully deployed, the jaws 228, 230 of grasping mechanism 216 can open to approximately seven and one half feet.

The waste-receiving truck bed 206 can be formed by a front wall 210, a back wall 211, and a pair of sidewalls 214. The pair of sidewalls 214 can be spaced apart by the respect widths of the front and back walls 210 and 211, respectively. Notably, each sidewall 214 can include an extension flap 212 that advantageously extends the height of each sidewall 214 beyond the respective heights of the front and back walls 210 and 211. Each extension flap 212 can be rotatably connected to each sidewall 214 and provide for increasing the total amount of construction waste placed in the waste-receiving truck bed 206 by retaining the waste in the waste-receiving truck bed 206 while the waste is being compacted by use of the grasping mechanism 216, to fill the waste-receiving truck bed 206 to its compacted waste capacity. Consequently, the use of the extension flaps 212 and/or the grappler 216 are a significant improvement over traditional roll-off containers and their associated roll-off trucks in that the transport vehicle 106 can have a full load that corresponds to the compacted capacity of one or more containers instead of a partial load that results from hauling a partially loaded (non-compacted) roll-off container to a waste depository.

In yet further illustration, FIG. 3 is a perspective view of a single section of the waste disposal chute shown in FIG. 1 and constructed in accordance with the principles of the present invention. As illustrated in FIG. 3, a chute section 110 can be a rolled steel tube, e.g., a three foot diameter tube made of 16 gauge galvanized steel, which defines a side wall 306, an upstream end 302 and a downstream end 304. The chute section 110 can have a cross section 312 or opening at its upstream end 302 equal to the cross section 314 or opening at its downstream end 304. In embodiments, the chute section 110 can have a lip or rim 308, 310 at the ends 302, 304 respectively. Notably, the lip or rim 308 of a first chute section 110 can be configured to engage the lip or rim 310 of a second chute section 110. At this point of engagement, the first chute section and the second chute section can be joined together in an end-to-end manner to form one continuous waste chute.

In embodiments, the ends can be joined together by the use of a weld or by use of a press fit. In embodiments, the cross-section or opening of the upstream end 302 can be slightly larger than the downstream end 304 such that the slightly smaller cross-section of the downstream end 304 can be pressed into an upstream end 302 to form a robust joint between the two chute sections 110. The formed robust joint further can be reinforced by welding. In embodiments, the chute section 110 can be made from other metals, e.g., 16-gauge galvanized sheet metal etc., to form the rolled tube, along with various diameters and/or gauges of metal thickness. In addition, as the height between the floors of a building will usually vary from about ten feet six inches to about fifteen feet six inches, the individual chute sections 110 can be from about ten feet six inches to about fifteen feet six inches. Alternatively, more than one chute section can be joined together to correspond to the floor high of that particular building.

In yet further illustration, FIG. 4 is a perspective view of a side angle hopper of the waste disposal chute section shown in FIG. 3. As illustrated in FIG. 4, a side angle hopper 114 can be fixed to a waste disposal chute section 110 to enclose an opening 403 for receiving waste into an assembled disposal chute 102. The side angle hopper 114 can have a pair of side panels 404 coupled to a bottom panel 406 and a rear panel 402, which defines the opening 403. In embodiments, the bottom panel 406 of the side angle hopper 114 can include multiple holes 408 for receiving bolts such that the side angle hopper 114 can be bolted to a building floor 108 to provide support to an assembled disposal chute 102. Although FIG. 4 illustrates a bottom panel 406 of the side angle hopper 114 with four holes 408, more or fewer holes may be provided in order to properly secure the side angle hopper 114 (and the waste disposal chute 102) to the building floor 108. In embodiments, the side angle hopper 114 can be made from other metals; e.g. 10-gauge galvanized sheet metal etc., to form the side angle hopper, along with various diameters and/or gauges of metal thickness.

In operation, the system for waste removal can be implemented to provide a more efficient process for waste removal from a construction site at a significant reduction in overall cost. The process for removing construction waste from a construction site can include transporting a set of waste chute sections to a construction site, assembling a waste chute by joining the set of waste chute sections together in an end-to-end matter and installing the waste chute into a multi-story building. The process further can include transporting one or more collapsible waste containers to a construction site, assembling the twenty to one hundred-twenty yard collapsible waste container by connecting the various side members to the base member and to the corresponding adjacent side member, positioning the one or more collapsible waste containers to receive waste from a downstream end of the installed waste chute and receiving waste from a downstream end of the installed waste chute. The process yet further can include providing a waste transport vehicle and removing the received waste from the collapsible waste container and place it in a waste-receiving bed of the waste transport vehicle. The received waste from the collapsible waste container can be packed or compressed into the waste-receiving bed of the waste transport vehicle by using a grasping mechanism 216, such as a grappler, or by using a pair of extension flaps 212. For example, the waste-receiving bed of the waste transport vehicle can have a capacity of forty compacted cubic yards. The waste transport vehicle removes the waste from a first waste container that has a capacity of twenty non-compacted cubic yards. Next, the waste transport vehicle removes the waste from a second waste container that has a capacity of twenty non-compacted cubic yards. The waste transport vehicle can be repositioned and can remove the waste from a third waste container that has a capacity of twenty non-compacted cubic yards. Next, the waste transport vehicle removes the waste from a fourth waste container that also has a capacity of twenty non-compacted. In this example, if traditional roll-off containers and associated roll-off trucks were used, it would require four separate trips to the central waste repository with corresponding charges for eighty cubic yards of waste. Instead, the disclosed waste removal system and process allows for a single trip to the central waste repository with corresponding charges for only forty compacted cubic yards of waste. Accordingly, the disclosed waste removal system and process saves a significant amount of labor, fuel, tire wears time and cost over conventional roll-off systems. Finally, the fully packed waste transport vehicle can travel to a central waste repository to unload the collected construction waste.

The invention has been described with respect to certain preferred embodiments, but the invention is not limited only to the particular constructions disclosed and shown in the drawings as examples, and also comprises the subject matter and such reasonable modifications or equivalents as are encompassed within the scope of the appended claims.

I claim:

1. A construction waste removal system comprising:
an assembled waste chute, the assembled waste chute comprising a set of waste chute sections that are joined together;
a collapsible waste container configured to receive waste from a downstream end of the assembled waste chute; and,
a waste transport vehicle comprising a main frame disposed along the longitudinal axis of the waste transport vehicle, a grasping mechanism configurable for removing waste from the collapsible waste container and disposed adjacent to an operator cab, and a waste-receiving vehicle bed coupled to the main frame.

2. The system of claim 1, wherein the grasping mechanism is a grappler mounted at a distal end of a boom.

3. The system of claim 2, wherein the grappler includes a first jaw, the first jaw including a cutting edge and defining a waste-engaging surface for compacting the waste in the waste-receiving vehicle bed.

4. The system of claim 3, wherein the grappler includes a second jaw opposed to the first jaw, the second jaw including a cutting edge and defining a waste-engaging surface for compacting the waste in the waste-receiving vehicle bed.

5. The system of claim 1, wherein an upstream end of one of the waste chute sections comprises a larger opening than a downside end of the one of the waste chute sections.

6. The system of claim 1, further comprising a pair of extension flaps rotatably connected to a pair of sidewalls of the waste-receiving vehicle bed and configured to retain the construction waste in the waste-receiving vehicle bed while the construction waste is being compacted.

7. The system of claim 1, wherein the waste chute section comprises a side angle hopper coupled to a side wall of the waste chute section.

8. A method for removing construction waste from a construction site, the method comprising:
transporting a set of waste chute sections to a construction site;
assembling a waste chute by joining the set of waste chute sections together;
installing the waste chute into a multi-story building;
transporting a collapsible waste container to a construction site;
positioning the collapsible waste container to receive waste from a downstream end of the installed waste chute; and,
receiving waste from a downstream end of the installed waste chute.

9. The method of claim 8, further comprising removing the collected construction waste from the collapsible waste container by use of a vehicle having a boom and a grappler.

10. The method of claim 9, further comprising placing the removed construction waste in a waste-receiving bed of the vehicle.

11. The method of claim 10, further comprising compressing the removed construction waste with the grappler.

12. The method of claim 8, further comprising deploying a pair of extension flaps rotatably connected to a pair of sidewalls coupled to the waste-receiving bed of the vehicle.

13. The method of claim 8, further comprising assembling the collapsible waste container at the construction site.

14. The method of claim 8, further comprising transporting the collected waste to a central repository.

15. A method for removing waste from waste containers, the method comprising:
transporting a waste collection vehicle to a plurality of waste containers,
positioning the waste collection vehicle adjacent one of the plurality of waste containers;
deploying a pair of extension flaps rotatably connected to a pair of sidewalls coupled to a waste-receiving bed of the waste collection vehicle;
activating a grasping mechanism located at a distal end of a boom of the waste collection vehicle;
removing the waste from the one of the plurality of waste containers by use of the grasping mechanism;
placing the removed waste in the waste-receiving bed of the waste collection vehicle; and,
using the grasping mechanism to compress the removed waste placed in the waste-receiving bed of the waste collection vehicle.

16. The method of claim 15, wherein removing the waste from the one of the plurality of waste containers comprises opening a first jaw and a second jaw of the grasping mechanism, engaging the waste between the first jaw and the second jaw of the grasping mechanism and retracting the grasping mechanism from the waste container.
